(19) United States
(12) Patent Application Publication
(10) Pub. No.: US 2026/0048524 A1
(43) Pub. Date: Feb. 19, 2026

(54) MILLING HEAD FOR PROFILING LOGS

(71) Applicant: Gebrüder Linck, Maschinenfabrik 'Gatterlinck' GmbH & Co. KG, Oberkirch (DE)

(72) Inventor: Albert HAAS, Appenweier (DE)

(73) Assignee: Gebrüder Linck, Maschinenfabrik 'Gatterlinck' GmbH & Co. KG, Oberkirch (DE)

(21) Appl. No.: 19/303,618

(22) Filed: Aug. 19, 2025

(30) Foreign Application Priority Data
Aug. 19, 2024 (DE) 102024123618.3

(51) Int. Cl. B27B 1/00; B27B 33/20

(52) U.S. Cl. CPC B27B 1/007; B27B 33/20

(57) ABSTRACT

A milling head for profiling logs has two rotating machining tools, the axes of rotation of which extend parallel to one another apart from possibly deviating inclination angles of the machining tools. The machining tools are designed to each create a circumferential and an end-side machining face and the position of the circumferential machining faces of the two machining tools is settable in relation to a log to be machined independently of the respective other machining tool. With such a settable milling head, a variable double step for the subsequent detachment of two side boards can be produced on each log side, which can be optimized independently of one another on account of the log contour.

### CROSS-REFERENCE TO RELATED APPLICATIONS

This application claims priority to German Patent application No. 10 2024 123 618.3, filed Aug. 19, 2024, which is incorporated herein by reference as if fully set forth.

### TECHNICAL FIELD

The present invention relates to a milling head for profiling logs. Furthermore, the invention relates to a method for producing side boards from a log, in which the log is first of all slabbed on four sides, subsequently corner regions are milled out and side boards delimited by the milled-out corner regions are detached by means of a saw.

### BACKGROUND

In the modern sawmill industry, logs are optically measured prior to sawing and the three-dimensional measurement data are used to determine an optimized cutting solution for each log. The actual machining of the log then takes place during an advancing movement. The log is first of all slabbed on four sides by means of so-called chipping canters. Subsequently, any waney corner regions are milled out. This is carried out by means of so-called corner milling cutters, wherein four milling heads are required on both sides in each case above and below the side board to be produced. Subsequently, the side boards delimited by the milled-out corner regions are detached by a saw cut. The squared timber is generally sawn in this case following the curvature of the log. To this end, the log which has been slabbed on four sides and milled out in corner regions is guided, following its curvature, through a saw. A corresponding machining method is described, for example, in EP 2 743 023 A1.

If two side boards are intended to be produced on each side, these are produced either successively by milling and sawing the first board and subsequently milling and sawing the second board. Alternatively, both side boards can be detached in one sawing step. To that end, however, two stepped corner regions have to be milled out at each corner before sawing, i.e. a first corner region is milled out with a first machine and subsequently a second corner region is milled out with a second machine. The two milling machines are thus arranged in succession in the transport direction. Accordingly, the plant becomes longer and especially, depending on the curvature of the logs, relatively large lateral deflections of the milling heads located farther away from the saw have to be accepted, since the tangential point of the curvature of the log when sawing following the curvature has to lie in the saw. It is structurally complicated to provide relatively large adjustment travels of the corner milling cutters and this also increases the time until the corner milling cutters are each set for the next log, this in turn requiring greater log spacings as they run through and thus reducing the throughput of the plant.

Also known from the market are stepped milling heads, in which two sets of blades are arranged at a fixed spacing from one another on a rotating machining tool, these being used to mill out a stepped corner contour on a log. The spacings of the two steps is fixedly defined in this case, however, and so only side boards with a defined thickness and with a defined width difference can be produced. This reduces the flexibility when optimizing the cutting solution and thus reduces the wood yield in favor of a higher throughput. In order to mill side boards with other dimensions, the plant has to be converted, this in turn resulting in downtimes.

### SUMMARY

Therefore, the invention addresses the problem of specifying a device with which two side boards can be produced per log, which can allow a compact structure of the plant equipped therewith and with which a higher throughput without a reduction in the wood yield can be achieved. The invention addresses the further problem of specifying a corresponding method for producing side boards from a log.

The problem is solved with regard to the device by a milling head having one or more of the features of disclosed herein and with regard to the method by one or more of the features disclosed herein directed to the method. Advantageous embodiments can be found in the description and claims that follow.

According to the invention, a milling head for profiling logs has two rotating machining tools, the axes of rotation of which extend parallel to one another apart from possibly deviating inclination angles of the machining tools, wherein the machining tools are designed to each create a circumferential and an end-side machining face and the position of the circumferential machining faces of the two machining tools is settable in relation to a log to be machined independently of the respectively other machining tool. With such a settable milling head, a variable double step for the subsequent detachment of two side boards can be produced on each log side, which can be optimized independently of one another on account of the log contour.

Preferably, provision may additionally be made for the two machining tools to be arranged so as to be adjustable in relation to one another in the direction of their axes of rotation, such that the respective positions of the end-side machining faces are also settable in relation to a log to be machined independently of the respectively other machining tool. In this way, side boards with board thicknesses that are settable independently of one another can be produced.

In a first preferred embodiment, the adjustability of the machining tools is achieved in that a first of the machining tools is mounted directly and the second machining tool is mounted via an eccentric on a common tool carrier. The position of the circumferential machining face of the first machining tool is in this case settable in relation to a log to be machined by adjustment of the tool carrier and the position of the circumferential machining face of the second machining tool is settable in relation to the log to be machined by rotation of the eccentric or of the tool carrier. Such a structure is extremely compact and requires few moving parts, and so the milling head is not susceptible to soiling and thus exhibits a high level of reliability.

In a particularly advantageous development, the two machining tools are driven in rotation via a common drive unit, and the machining tools are coupled rotationally together via a transmission accommodated within the eccentric. This results in a particularly simple and compact construction and only one drive unit is required.

Preferably, as a result of the eccentric, the axes of rotation of the two machining tools can extend parallel to one another but be arranged in an offset manner relative to one another. As a result of the eccentric being rotated about a central axis, which may in particular be identical to the axis of rotation of the first machining tool, the position of the circumferential machining face of the second machining tool is settable as a result.

In a preferred embodiment, the first machining tool is carried by a hollow shaft which is mounted so as to be rotatable about the eccentric. In this case, the eccentric can be carried by an eccentric shaft which extends within a first hub on which the hollow shaft is rotatably mounted, preferably wherein the eccentric shaft is coupled to the first hub for conjoint rotation but so as to be axially movable.

In a further preferred embodiment, the eccentric has a cylindrical head region which is arranged in an offset manner relative to the eccentric shaft. In this case, the axis of rotation of the second machining tool extends through the central axis of the cylindrical head region.

In a particularly preferred development of the invention, the two machining tools are driven in rotation synchronously, and the machining tools are each subdivided into tool segments, wherein the tool segments of the two machining tools mesh with one another. As a result of the synchronized rotational drive, the interlocked tool segments do not get in each other's way, and so the machining tools can be moved relative to one another in order to variably set the milling geometry. In addition to a compact structure, this allows a large adjustment range of the machining tools. While it would, in principle, be possible to synchronize the separate rotational drives for the machining tools, the synchronicity can be achieved, in particular, as set out above, by a common rotational drive when the machining tools are rotationally coupled

With an identical number of tool segments, the machining tools can be driven with the same angular speed. With a different number of tool segments, the angular speeds of the two machining tools can be in inverse proportion to the number of tool segments per machining tool. The ratio of the angular speeds can be realized easily by way of a corresponding gear ratio when the machining tools are rotationally coupled.

In one development, the transmission may have a ring gear flange with an internal toothing, said ring gear flange being connected to the hollow shaft. A gearwheel engaging with the internal toothing drives, via a transmission shaft, a second ring gear which is connected to a second hub which carries the second machining tool.

In a preferred embodiment, the two machining tools having different diameters, and the axis of rotation of the second, smaller-diameter machining tool extends within the cross-sectional area of the first, larger-diameter machining tool and in an offset manner in relation to the axis of rotation thereof. As a result, settable step geometries can be achieved very easily and with a compact structure.

Expediently, provision may be made for the tool segments of the two machining tools to each comprise at least one circumferentially arranged chopper and a circular saw segment arranged on the end side. With circumferential choppers, a clean circumferential machining face can be created and with the circular saw segments, an end-side machining face can be created without cracks in the wood.

With the circular saw segments arranged on the end side, provision may be made, to increase the service life, for the length of some teeth of a segment, i.e. the radial spacing of the sawtooth tips from the axis of rotation of the milling head to increase with the saw segments, counter to the direction of rotation. Thus, the front teeth do not have to achieve the highest cutting performance and therefore do not wear down prematurely.

In the circumferential direction, the tool segments of the machining tools can have two or more choppers arranged in an offset manner in the axial direction and in the radial direction, the cutting ranges of which overlap or at least adjoin one another. In this way, the cutting performance is distributed over a plurality of choppers, this likewise increasing the service life thereof and allowing a larger machining area. Furthermore, as a result of the geometry of the choppers, wood chips with defined geometric requirements can be produced, which can be further processed in different industrial applications and thus have an additional utility. The thickness of the wood chips results from the advancing movement of the log, the number of choppers in the circumferential direction, and the rotational speed of the milling head.

If the machining tools are driven in rotation via a common drive unit, the force transmission from the common drive unit to one of the two machining tools can take place via a drive belt. A belt drive allows high torques, is simple and robust, and less susceptible to soiling. Alternatively, some other kind of force transmission, for instance using a drive chain or a direct drive, would also be possible, of course.

In the method according to the invention for producing lumber, the log is first of all slabbed on four sides, subsequently corner regions are milled out and side boards delimited by the milled-out corner regions are detached by means of a saw. According to the invention, in the milling step, stepped corner regions are milled out using milling heads of the above-described type, and, in the subsequent sawing step, two side boards, delimited by the stepped corner regions, are detached on each side of the log. In this case, for each log, the position of the circumferential machining faces of the two machining tools of each milling head is set in relation to a log to be machined independently of the respectively other machining tool of the milling head.

Preferably, the log is three-dimensionally measured optically before or after slabbing and the measurement data are used to determine an optimized cutting solution which comprises the side boards. The position of the circumferential machining faces of the milling heads is then set at the dimension determined for the side boards in the cutting solution.

In a preferred development, the log is guided through the saw by means of adjustable transport and guide rollers, following its curvature. In the process, the milling heads are carried along as the log passes through, such that the resulting milled contour corresponds to the profile of the side boards determined in the cutting solution. As a result of the incision following the curvature, the yield is increased considerably. In order that the tangential point of the incision curve lies in the saw and thus transverse forces on the saw blades are reduced, the milling heads are carried along as the log passes through. As a result, it is possible to produce not only side boards oriented parallel to the log axis, but also side boards oriented at an angle to the log profile, or side boards having a precalculated longitudinal bend along their narrow side (crook).

The milling step using milling heads according to the invention can be carried out both before the detachment of side boards during precutting, or before the log is split up into main and side boards during recutting, or in both cases. In other words, by means of the milling heads according to the invention, the log can be profiled to produce two precut side boards per side and two side boards per side during recutting.

### BRIEF DESCRIPTION OF THE DRAWINGS

Further advantages and properties will become apparent from the following description of exemplary embodiments with reference to the figures, in which:

FIG. 1 shows an isometric view of a milling head with an associated drive unit in an exemplary embodiment according to the invention with an eccentrically mounted inner machining tool,

FIG. 2 shows a plan view of the milling head from FIG. 1,

FIG. 3 shows a sectional illustration along the line A-A in FIG. 2,

FIG. 4 shows an isometric view of the disassembled milling head from FIG. 1 with the outer rotating machining tool thereof,

FIG. 5 shows an isometric view of the inner rotating machining tool, removed in FIG. 4, with the eccentric on which it is mounted,

FIG. 6 shows an isometric illustration of a transmission, received in the eccentric from FIG. 5, for rotationally coupling the two machining tools of the milling head,

FIG. 7 shows an isometric view of a milling head with an associated drive unit in a second example with separate tool carriers for the two machining tools thereof,

FIG. 8 shows a plan view of the milling head from FIG. 7,

FIG. 9 shows a sectional illustration along the line A-A in FIG. 8,

FIG. 10 shows an isometric view of the removed inner machining tool of the milling head from FIG. 7 with an associated tool carrier and a universal shaft for rotationally coupling the machining tools,

FIG. 11 shows an isometric view of the milling head from FIG. 8 without the removed inner machining tool from FIG. 10,

FIG. 12 shows a rear view of the partially removed milling head from FIG. 11,

FIG. 13 shows a simplified schematic drawing for explaining the operating principle of the second example,

FIG. 14 shows a simplified schematic drawing for explaining the operating principle of the exemplary embodiment according to the invention, and

FIGS. 15 and 16 show a simplified schematic drawing in a front and a side view for explaining an optional tool inclination.

### DETAILED DESCRIPTION

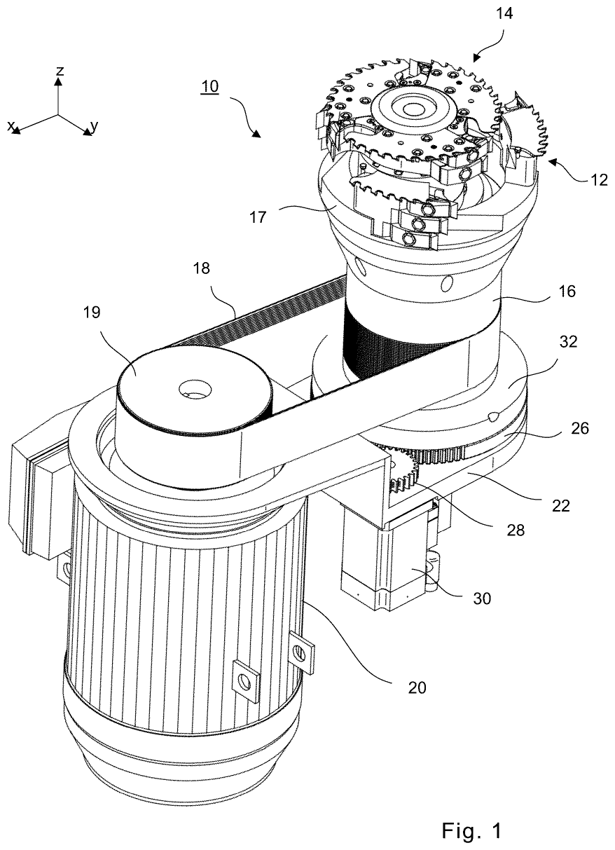

In the first exemplary embodiment illustrated in FIGS. 1 to 6, a milling head 10 has a first, outer rotating machining tool 12 and a second, inner rotating machining tool 14, which has a smaller diameter than the outer machining tool 12.

The outer machining tool 12 is carried by a hollow shaft 16, which is driven by a drive motor 20 via a drive belt 18, with the machining tool 12 thus being set in rotation during operation. In an alternative embodiment that is not shown here, it is also conceivable, rather than a drive belt 18, to use an alternative element for force and movement transmission or to arrange the drive motor 20 in such a way that it directly drives the hollow shaft 16.

The hollow shaft 16 is mounted rotatably on a tool carrier 22. The tool carrier is adjustable in the x and z direction, in a manner known per se, via linear actuators and corresponding guides (not shown), wherein the y direction represents the transport direction of a log to be machined.

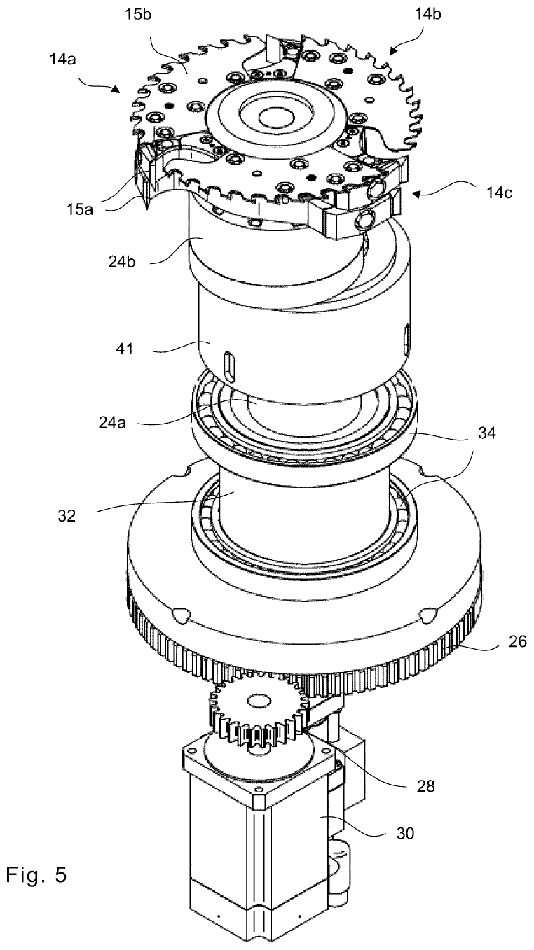

Located inside the hollow shaft 16 is an eccentric 24 (FIG. 5), against which the hollow shaft 16 is rotationally mounted. The eccentric carries the inner machining tool 14. The eccentric 24 is fastened to a rotating assembly 26 that is provided with an outer toothing and can be rotated by a servomotor 30 via a pinion 28. In a manner not shown here, it would also be conceivable for the eccentric 24 to be rotated not via the rotating assembly 26 and the servomotor 30 but by means of any other desired actuating means. For example, a lever element comes into consideration, which is connected to the eccentric 24 instead of the rotating assembly 26 and is able to be actuated by means of a servo-hydraulic actuator.

The two machining tools 12, 14 are milling units of a milling head. These are each subdivided into three tool segments 12a, 12b, 12c and 14a, 14b, 14c. The tool segments 12a, 12b, 12c of the outer machining tool 12 each have three choppers 13a that are arranged in a radially and axially offset manner in the circumferential direction, and an end-side circular saw segment 13b. When used on a log, the machining tool 12 thus creates, via the circular saw segments 13b, an end-side machining face and, via the circumferential choppers 13a, a circumferential machining face, which are oriented perpendicularly to one another. In a manner not shown here, rather than three tool segments 12a, 12b, 12c and 14a, 14b, 14c, respectively, it is also possible for fewer or more tool segments to be provided, which are distributed circumferentially, in particular in a number of between two and eight, such that it is also possible, for example, for there to be six tool segments. It is also conceivable for fewer or more than three choppers 13a to be provided per tool segments 12a, 12b, 12c and 14a, 14b, 14c, respectively.

In a corresponding manner, the tool segments 14a, 14b, 14c of the inner machining tool 14 also each have two choppers 15a that are arranged in a radially and axially offset manner in the circumferential direction, and an end-side circular saw segment 15b, which, when used on a log, produce an end-side machining face and a circumferential machining face perpendicularly thereto.

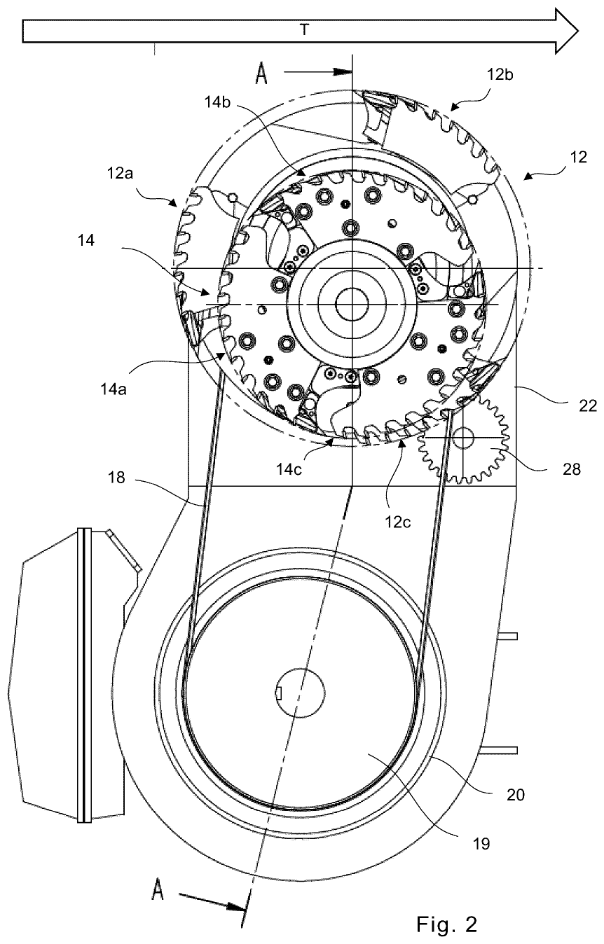

In the plan view in FIG. 2, the tool segments, and the end-side circular saw segments thereof, are readily apparent. It is also clear that, as a result of the eccentric 24, the axes of rotation of the two machining tools 12, 14 extend parallel to one another but are arranged in an offset manner relative to one another. If a log is envisioned for example along the arrow T, the tool segments of the outer machining tool 12 penetrate more deeply into the log than the tool segments of the machining tool 14 that are located farther away, such that two stepped corners are milled into the log. As a result of the eccentric 24 being rotated, the axis of rotation is moved closer to the log, which runs through along the arrow line T, such that the spacing of the circumferential machining faces at the log is reduced. The incision depth of the outer machining tool 12 can thus be set by adjustment of the tool carrier 22, and the incision depth of the inner machining tool 14 can be set by additional rotation of the eccentric 24 via the rotating assembly 26.

Alternatively to the rotation of the eccentric 24, it is, of course, also possible for the entire tool carrier 22, with or without the drive unit 20, to be rotated; although this would be technically more complicated to realize, it would have the same effect of relative rotation of the eccentric with respect to the log.

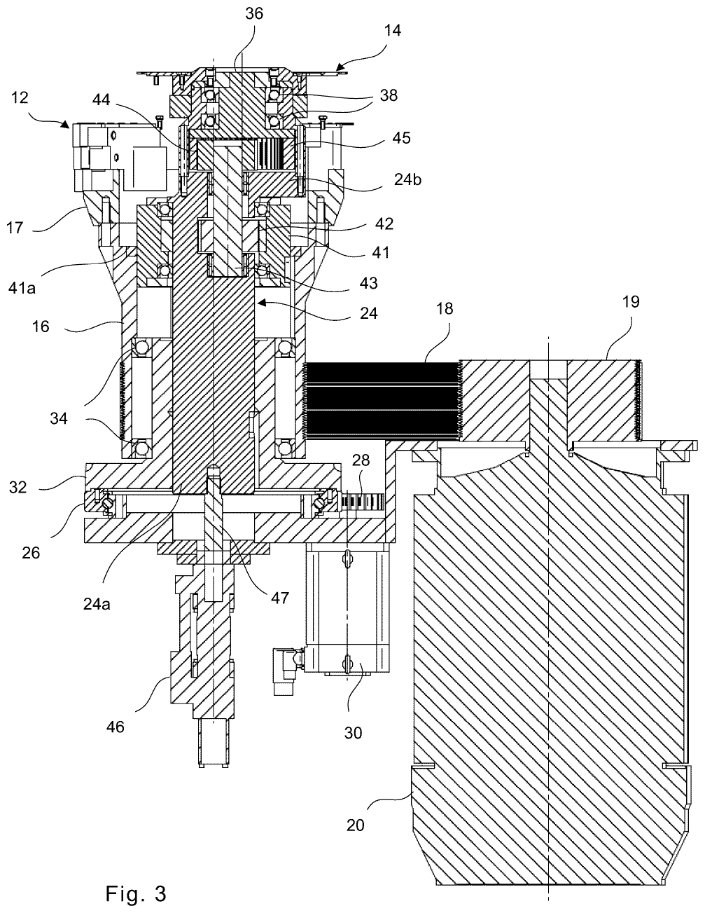

The manner in which the hollow shaft 16 is mounted around the eccentric 24 is apparent from the sectional drawing in FIG. 3. Fitted on the rotating assembly 26 is a hub 32. Around the latter, the hollow shaft 16 is rotatably mounted via two axially spaced-apart bearings 34. The drive belt 18 runs around the hollow shaft and a pulley 19, which is driven by the drive motor 20, in order to set the hollow shaft 16 in rotation. In the section, the entire drive motor 20, which will not be described in detail here, is illustrated in a hatched manner for the sake of simplicity. The end of the hollow shaft 16 carries a tool receptacle 17, to which the outer machining tool 12 is attached.

The shaft 24a of the eccentric 24 extends within the hub. Said shaft is coupled to the hub 32 for conjoint rotation but so as to be axially movable. The cylindrical head region 24b of the eccentric 24 is arranged in an offset manner relative to the axis of the eccentric shaft 24a, such that, as a result of rotation of the eccentric axis, the spacing of the eccentric head 24b from a log to be machined is set by the eccentric movement. Arranged on the eccentric 24 is a hub 36, on which the upper or inner machining tool 14 is rotatably mounted with two rolling bearings 38.

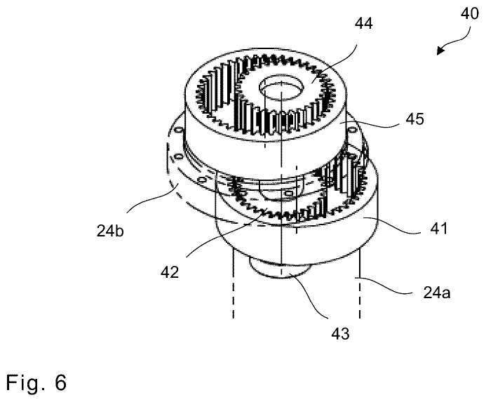

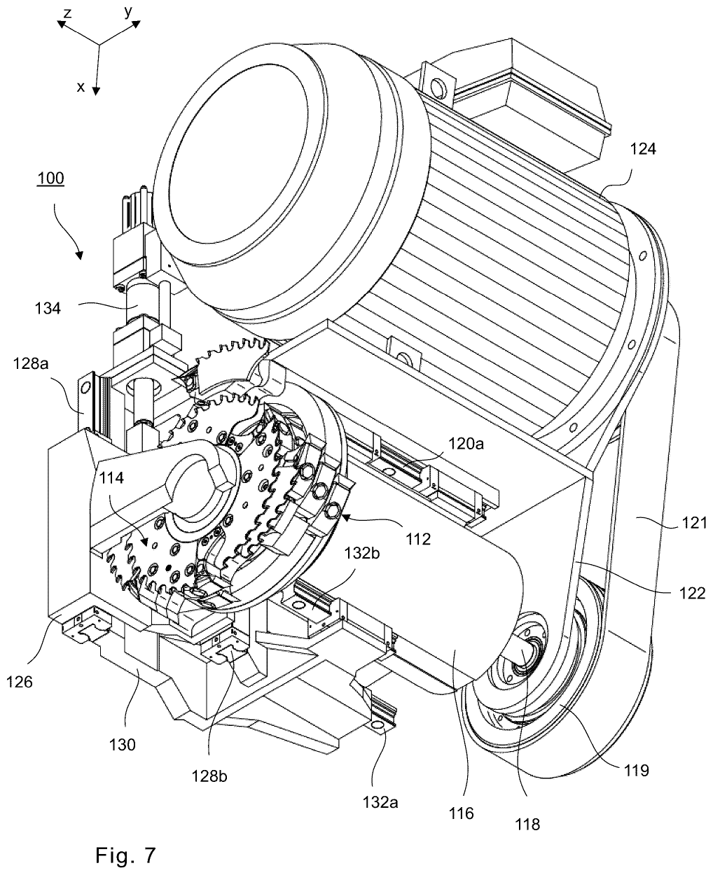

The inner machining tool 14 is driven in rotation via a transmission 40, illustrated in more detail in FIGS. 6 and 7, which is accommodated inside the eccentric 16. Said transmission comprises a ring gear flange 41, which is connected to the hollow shaft 16, for example via a key, and sealed relative to the hollow shaft via a seal 41a. The ring gear flange 41 has an internal toothing with which a first gearwheel 42 engages. The latter is connected via a transmission shaft 43 to a second gearwheel 44, which drives a ring gear 45 that is connected to the hub 36. Thus, the inner machining tool 14 is driven in rotation in a synchronized manner with the outer machining tool 12.

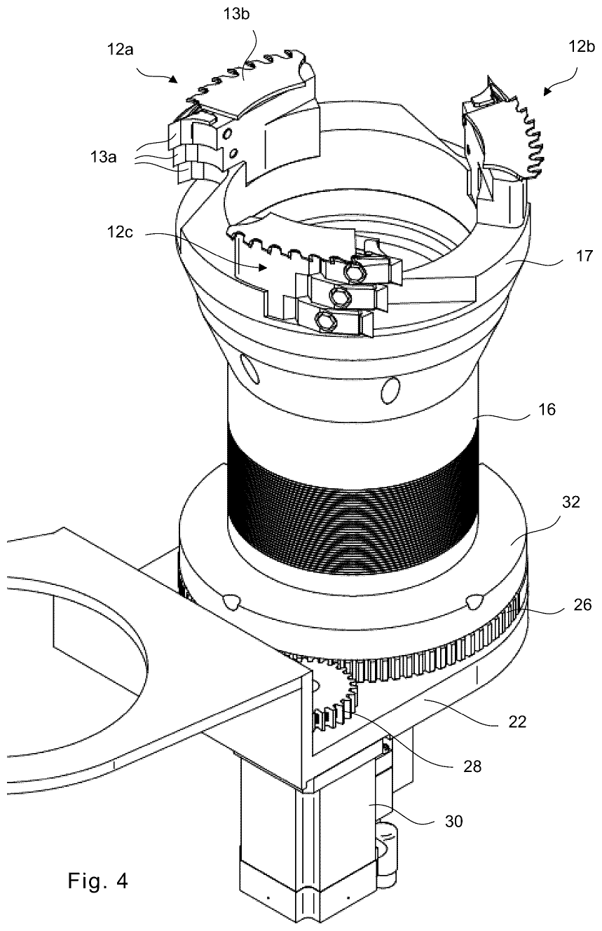

FIGS. 4 and 5 show the milling head in a disassembled manner. FIG. 4 illustrates only the hollow shaft 16 with the outer machining tool 12 and the tool carrier 22, and also the rotating assembly 26 and the servomotor 30 together with the pinion 28. The eccentric 24 with the transmission 40 and the inner machining tool 14 has been removed here. This unit is illustrated in FIG. 5. It is apparent from FIG. 4 that the tool segments 12a, 12b, 12c are each separated by relatively large circumferential gaps. These are larger than the width of the choppers 13a of the tool segments 14a, 14b, 14c, illustrated in FIG. 5, of the inner machining tool 14. This makes it possible for the tool segments 14a, 14b, 14c to pass into the gaps between the segments 12a, 12b, 12c, such that the tool segments 12a, 12b, 12c, 14a, 14b, 14c of the two machining tools 12, 14 mesh with one another given a synchronized rotational movement.

The two machining tools 12, 14 can thus be adjusted with respect to one another and into one another within a certain setting range. For this purpose, the eccentric 24 is designed to be movable in the axial direction and is connected to the piston rod 47 of a hydraulic cylinder 46. The hydraulic cylinder 46 thus serves as a linear drive in order to adjust the machining tools 12, 14 relative to one another by axial adjustment of the eccentric. In this way, the respective position of the end-side machining faces of the machining tools 12, 14 can also be set in relation to a log to be machined independently of the respectively other machining tool, specifically the end-side machining face of the outer machining tool 12 by adjustment of the tool holder 22 and the end-side machining face of the inner machining tool 14 by axial adjustment of the eccentric 24 via the hydraulic cylinder 46.

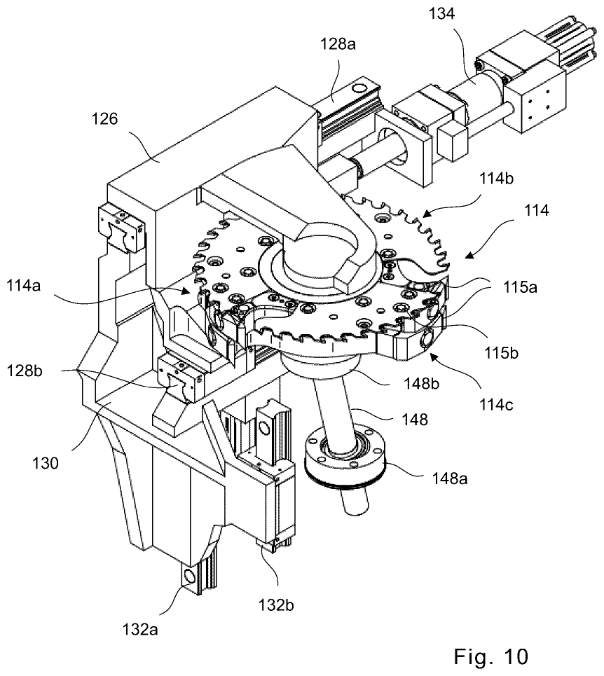

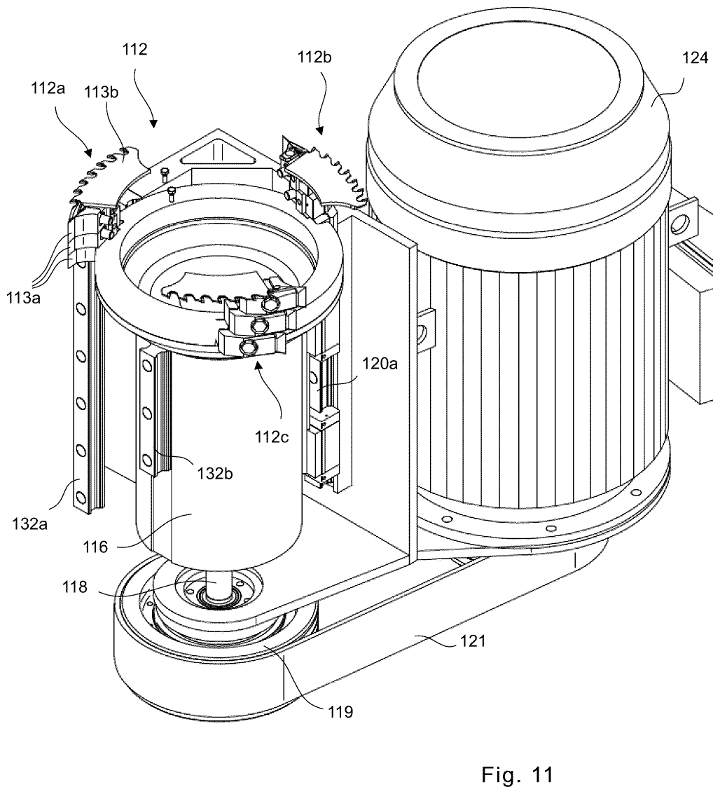

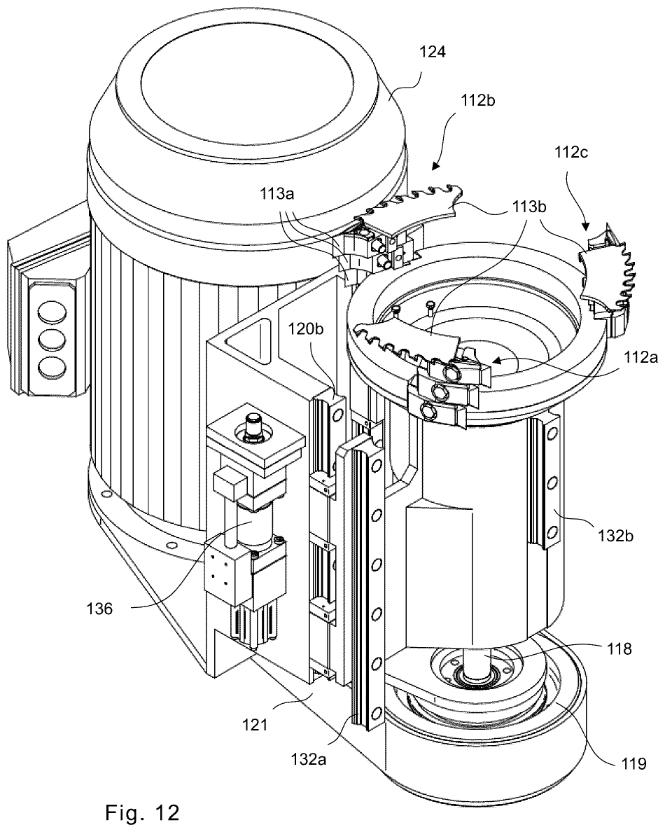

A second, currently not claimed example of a milling head 100 having two rotating machining tools 112, 114 is illustrated in FIGS. 7 to 12 and is explained in the following text for better understanding of the invention. The outer milling head 112 is rotatably mounted in a housing 116. The housing 116 is mounted adjustably on a first tool carrier 122 via a rail guide 120a, 120b (see FIG. 12).

The outer milling head 112 is driven via a shaft 118, which is provided with a pulley 119 and is driven by a drive motor 124 via a drive belt 121. Since the shaft 118 undergoes a change in length upon adjustment of the housing 116, it can be realized by a universal shaft or a splined shaft with an axially movable toothed hub. A universal shaft would in this case not have to compensate an angular offset per se, but, as stated, only a change in length; however, it affords the advantage that the required tolerances between the pulley 119 and the receptacle of the machining tool 112 need to be less tight.

Rather than the housing 116, the entire tool carrier 122 together with the drive motor 124 could, of course, also be adjusted. Length compensation of the shaft 118 could then be dispensed with. However, a much greater mass would then have to be moved, and this requires proportionately more drive energy or longer adjustment times.

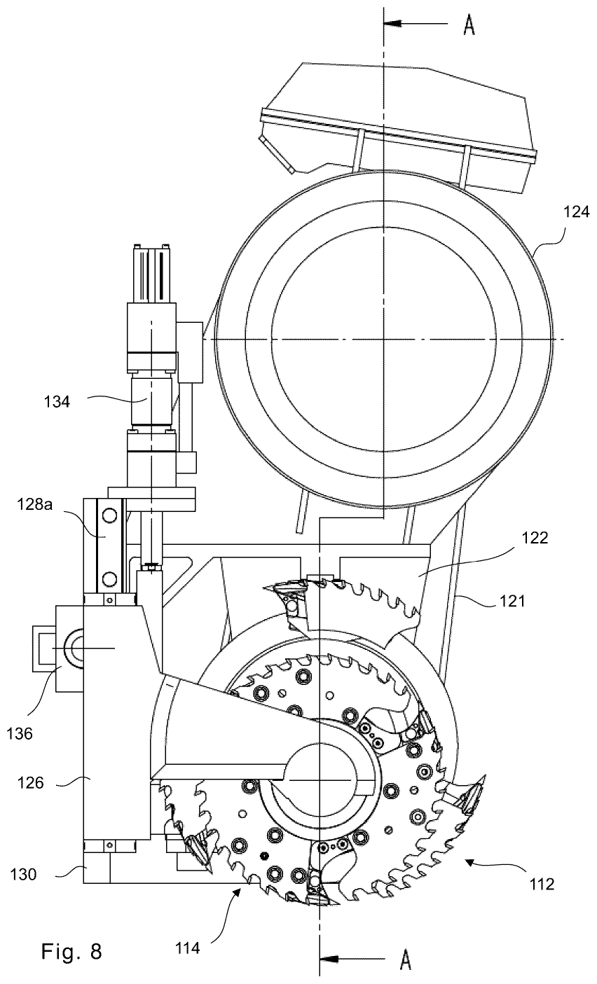

The inner machining tool 114 is mounted on a bearing carrier 126. This is mounted on a second tool carrier 130 so as to be adjustable in the x direction via a rail guide 128a, 128b. The second tool carrier 130 is in turn fastened to the housing 116 so as to be longitudinally movable in the z direction via a rail guide 132a, 132b. Via corresponding linear drives 134, 136 (see FIG. 8), the bearing carrier 126 can be adjusted in the x direction relative to the second tool carrier 130, and the second tool carrier 130 can be adjusted in the z direction relative to the housing 116. Thus, the inner machining tool 114 can be positioned within an adjustment range independently of the position of the outer machining tool 112.

The outer machining tool 112 is positioned by external positioning of the tool carrier 122 in the x direction and by adjustment of the housing 116 in the z direction with respect to the tool carrier 122 by corresponding linear drives (not shown).

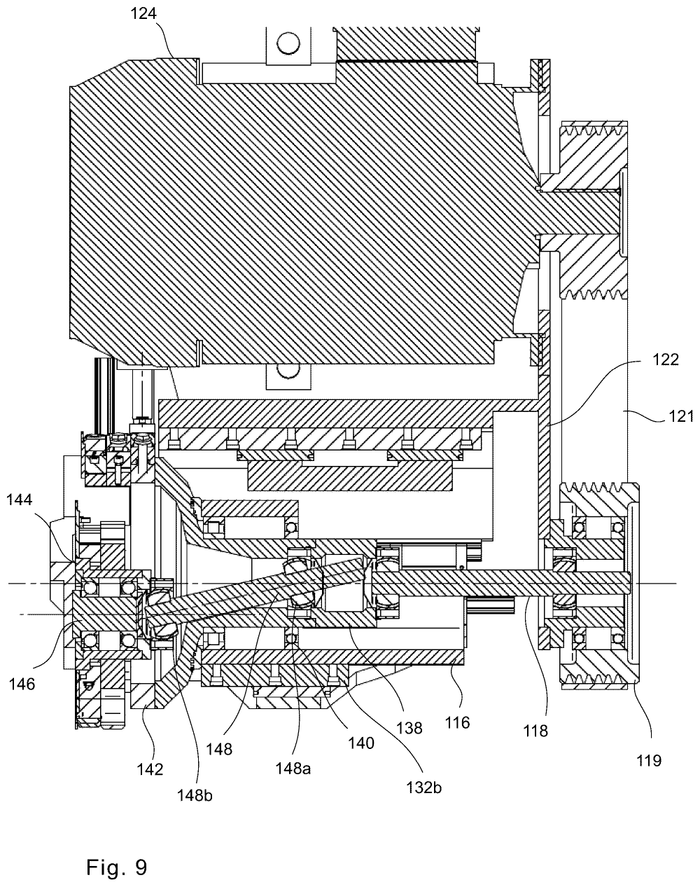

The inner machining tool 114 is driven by being rotationally coupled to the outer machining tool 112. As is apparent from the sectional illustration in FIG. 9, the shaft 118 drives a flange 138, which is mounted rotatably in the housing 116 via the bearing 140. Toward its end, the rotatable flange 138 widens and carries a tool receptacle 142 on which the tool segments 112a, 112b, 112c of the outer machining tool 112 are arranged. As in the first exemplary embodiment, the tool segments 112a, 112b, 112c each comprise three choppers 113a that are arranged in a radially and axially offset manner in the circumferential direction, and an end-side circular saw segment 113b.

The inner machining tool 114, as in the first exemplary embodiment, is also subdivided into three tool segments 114a, 114b, 114c, which respectively comprise two choppers 115a arranged in an offset manner and an end-side circular saw segment 115b. These are carried by a tool receptacle 144, which is mounted rotatably about a hub 146 arranged on the bearing carrier 126. The rotational coupling of the tool receptacle 144 of the inner machining tool 114 to the rotatable flange 138, which carries the outer machining tool 112, takes place by way of a universal shaft 148 that extends obliquely within the flange 138 in FIG. 9. The universal shaft 148 comprises two universal or ball joints 148a, 148b for angular compensation and a slide, connecting the universal or ball joints 148a, 148b, for length compensation. It compensates an offset, settable by adjustment of the bearing carrier 126, between the axes of rotation of the outer and inner machining tool 112, 114 and also allows length compensation upon adjustment of the tool carrier 130 in the z direction relative to the tool carrier 122 or the housing 116 mounted movably thereon.

As also in the first exemplary embodiment, the rotational coupling of the machining tools 112, 114 in this case ensures, by means of the universal joint 148, a synchronized rotational movement, such that the tool segments 112a, 112b, 112c, 114a, 114b, 114c of the two machining tools 112, 114 can mesh with one another. The two machining tools 112, 114 can thus also be adjusted with respect to one another and into one another in a certain setting range here too.

The milling tool of the second example is characterized in that the two machining tools 112, 114 are mounted on separate tool carriers 122, 130, and the position of the circumferential machining face of each of the two machining tools 112, 114 in relation to a log to be machined is settable by adjustment of the associated tool carrier 122, 130.

According to one development, in the milling head 100 of the second example, the two machining tools 12, 14 are driven in rotation via a common drive unit 124, and the machining tools 112, 114 are coupled rotationally together via a universal joint 148.

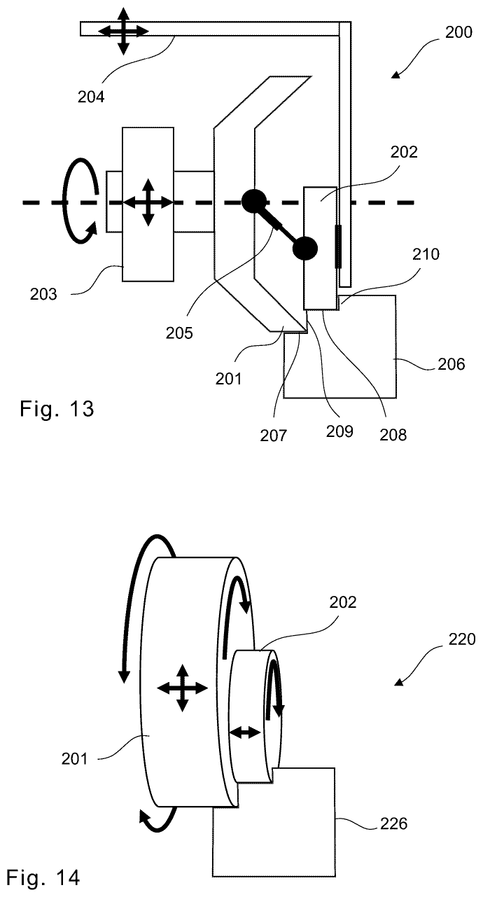

With reference to FIG. 13, the operating principle underlying the second example will be explained again. The milling head 200 has two rotatable machining tools 201, 202, an inner one and an outer one. The outer machining tool 201 is mounted on a first tool carrier 203, and the inner machining tool is mounted on a second, separate tool carrier 204. Both are adjustable in the x and z direction independently of one another. Via a universal shaft 205, the two machining tools are rotationally coupled, such that they can both be driven via a drive motor which is coupled to one of the two machining tools.

Also schematically shown is a log 206 that has been slabbed on four sides, a so-called “squared timber”, which possibly still has waney regions which are milled out with the milling head according to the invention in order subsequently to detach so-called side boards. The log 206 is in this case transported toward the milling head 200 in a direction out of the plane of the drawing (y direction), i.e. guided past the positionally fixed milling head 200 and the machining tools 201, 202 thereof. Each of the machining tools 201, 202 mills a corner profile with two perpendicular machining faces out of the log 206. At the perpendicular edges of each of the corner profiles, a respective side board can subsequently be detached by way of a saw cut.

Each of the corner profiles has a machining face 207, 208 that is circumferential with respect to the respective machining tool 201, 202, and an end-side machining face 209, 210. The positions of the corner regions are settable independently of one another. To this end, the two tool carriers 203, 204 are settable in the x and z direction. As a result of adjustment in the x direction (vertically in the drawing), the width and the position of the side board are set with regard to the log 206, and by adjustment in the z direction (horizontal in the drawing), the board thickness is set. Adjustment in the x direction can also take place in a controlled manner while a log 206 passes through. In this way, a side board with a profile that is inclined with respect to the log axis or a side board that is curved along its long narrow side (crook) can be produced, in order, for example, to optimize the wood yield depending on a log curvature.

FIG. 14 shows a comparable schematic illustration, with reference to which the operating principle underlying the first exemplary embodiment, according to the invention, will be summarized once again. The milling head 220 shown therein again has a first, outer machining tool 221 and a second, inner machining tool 222. These are mounted eccentrically relative to one another and rotationally coupled, such that only the outer machining tool 221 needs to be driven. The outer machining tool 221 is adjustable in the x and z direction via a common tool carrier (not shown here). The inner machining tool is adjustable in the z direction (horizontally in the plane of the drawing). Furthermore, the eccentric axis can be rotated, with the result that the incision depth of the inner machining tool (x direction) and thus the width and the position of the relevant side board with respect to the log 226 are set.

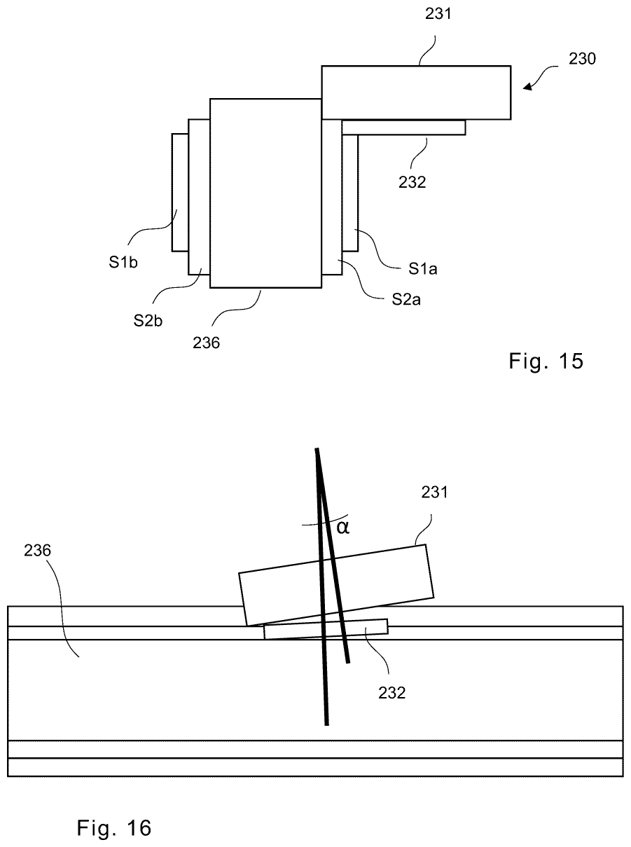

FIGS. 14 and 15 show two further schematic illustrations, with reference to which possibly existing inclination angles of the machining tools are intended to be explained. In FIG. 14, a log 236 with a milled profile is apparent in cross section. At each of the four corners, a double corner profile has been milled out as explained above. To this end, four milling heads are used. Along the perpendicularly extending lines that delimit the corner profiles, a respective side board S1a, S2a, S1b, S2b can be detached.

By way of example, a milling head 230 having an outer and an inner machining tool 231, 232 is shown here. In FIG. 15, the same log 236 is shown during machining, wherein the conveying direction of the log 236 extends from left to right. The two machining tools can now be inclined with respect to the conveying direction at an angle a, the so-called inclination angle or camber. This has the purpose of avoiding recutting of the already machined machining face by the trailing tool side. Depending on the tool geometry, this angle can be defined in order to create a machining face that is as planar as possible without cracks. This angle, which is illustrated in an exaggerated manner in FIG. 15 for greater clarity and is barely more than a few tenths of a degree in practice, can possibly differ for the two machining tools 231, 232.

Methods for producing lumber, in which the milling heads according to the invention can be used, are known per se. One method, in which a log is first of all slabbed on two sides, then rotated and slabbed on the remaining two sides, is known, for example, from EP 2 743 023 A1 mentioned at the beginning, to which reference is made in full to avoid unnecessary repetitions. Following slabbing, the log is rotated back again and a first corner region is milled out in a milling cutter and a respective side board is detached on both sides during precutting in a saw. As a result of the use of milling heads according to the invention of the above-described type, in this method, two side boards of individually settable width and preferably also individually settable thickness can now be detached per side in a single milling step and a subsequent sawing step.

The described method provides, after the detachment of the side boards during precutting, that the log is rotated back into the starting position and further corner regions for side boards are milled out during recutting. The log profiled in this way is then guided through a saw, following its curvature, said saw both detaching the side boards along the milled corner regions and also, at the same time, splitting the main cut of the log in accordance with the previously determined cutting solution. In the second milling step, before splitting into main and side cuts during recutting, it is possible for milling heads according to the invention to be used and thus, in addition to the main cut, for two side boards to be produced per side in a single milling step and subsequent sawing step.

A further known method is described in DE 10 2022 132 324 A1, to which reference is likewise made in full here. The method described therein manages without rotation of the log, in that the log is slabbed vertically and horizontally with successive chipping canters. Subsequently, first corner regions are milled and first side boards are detached during precutting in a horizontal direction. Subsequently, second milling of corner regions and sawing of the log into main and side cuts take place in a vertical direction. In both cases, both for profiling the log before detaching the precut side cut, and for profiling the log before it is split into main and side cuts during recutting, milling heads according to the invention can be used in order to respectively produce two precut side boards per side and two further side boards per side during recutting.

1. A milling head (10) for profiling logs, the milling head comprising:
two rotating machining tools (12, 14), axes of rotation of which extend parallel to one another apart from possibly deviating inclination angles of the machining tools (12, 14), the machining tools (12, 14) are arranged and adapted to each create a circumferential machining face and an end-side machining face, and a position of the circumferential machining faces of the two machining tools (12, 14) is settable in relation to a log to be machined independently of the respective other of the machining tools (12, 14),
wherein a first of the two machining tools (12) is mounted directly and the second of the machining tool a (14) is mounted via an eccentric (24) on a common tool carrier (22), and
a position of the circumferential machining face of the first machining tool (12) is settable in relation to a log to be machined by adjustment of the tool carrier (22) and a position of the circumferential machining face of the second machining tool (14) is settable in relation to the log to be machined by rotation of the eccentric (24) or the tool carrier (22).

2. The milling head (10) as claimed in claim 1, wherein the two machining tools (12, 14) are arranged so as to be adjustable in relation to one another in a direction of the axes of rotation thereof, such that respective positions of the end-side machining faces are also settable in relation to a log (226, 236) to be machined independently of the respective other of the machining tools (12, 14).

3. The milling head (10) as claimed in claim 1, wherein, as a result of the eccentric (24), the axes of rotation of the two machining tools (12, 14) extend parallel to one another and are arranged in an offset manner relative to one another, and as a result of the eccentric (24) being rotated about a central axis, the position of the circumferential machining face of the second machining tool (14) is settable.

4. The milling head (10) as claimed in claim 3, wherein the central axis and the axis of rotation of the first machining tool are identical.

5. The milling head (10) as claimed in claim 1, further comprising a hollow shaft (16) which carries the first machining tool (12), the hollow shaft (16) is mounted so as to be rotatable about the eccentric (24).

6. The milling head (10) as claimed in claim 5, wherein the eccentric (24) is carried by an eccentric shaft (24a) which extends within a first hub (32) on which the hollow shaft (16) is rotatably mounted, and the eccentric shaft (24a) is coupled to the first hub (32) for conjoint rotation and to be axially movable.

7. The milling head (10) as claimed in claim 6, wherein the eccentric (24) has a cylindrical head region (24b) which is arranged in an offset manner relative to the eccentric shaft (24a), and the axis of rotation of the second machining tool (14) extends through the central axis of the cylindrical head region (24b).

8. The milling head (10) as claimed in claim 1, wherein the two machining tools (12, 14) are driven in rotation via a common drive unit (20), and the machining tools (12, 14) are coupled rotationally together via a transmission (40) accommodated within the eccentric (24).

9. The milling head (10) as claimed in claim 8, wherein the transmission (40) has a ring gear flange (41) with an internal toothing, said ring gear flange being connected to the hollow shaft (16), and a gearwheel (42) engages with the internal toothing, said gearwheel driving, via a transmission shaft (43), a second ring gear (45) which is connected to a second hub (36) which carries the second machining tool (14).

10. The milling head (10) as claimed in claim 1, wherein the two machining tools (12, 14) are driven in rotation synchronously, and the two machining tools (12, 14) are each subdivided into tool segments (12a, 12b, 12c, 14a, 14b, 14c) and the tool segments (12a, 12b, 12c, 14a, 14b, 14c) of the two machining tools (12, 14) mesh with one another.

11. The milling head (10) as claimed in claim 10, wherein angular speeds of the two machining tools (12, 14) are in inverse proportion to a number of the tool segments (12a, 12b, 12c, 14a, 14b, 14c) per each said machining tool (12, 14).

12. The milling head (10) as claimed in claim 1, wherein the two machining tools (12, 14) having different diameters, and the axis of rotation of the second machining tool (14), which has a smaller-diameter than the first machining tool (12), extends within a cross-sectional area of the first machining tool (12), which is of larger diameter, and in an offset position in relation to the axis of rotation thereof.

13. The milling head (10) as claimed in claim 10, wherein the tool segments (12a, 12b, 12c, 14a, 14b, 14c) of the two machining tools (12, 14) each comprise at least one circumferentially arranged chopper (13a, 15a) and a circular saw segment (13b, 15b) arranged on an end side.

14. A method for producing lumber (S1a, S2a, S1b, S2b) from a log (206, 226, 236), the method comprising:
first, slabbing the log (206, 226, 236) is first on four sides;
subsequently, milling out corner regions;
detaching side boards (S1a, S2a, S1b, S2b) delimited by the milled-out corner regions by sawing;
wherein, in the milling out of the corner regions, stepped corner regions are milled out using milling heads (10, 100; 200, 220, 230) as claimed in claim 1, and,
in the detaching of the side boards by sawing, detaching two of the side boards (S1a, S2a, S1b, S2b), delimited by the stepped corner regions, on each side of the log (226, 236), and
wherein, for each said log (226, 236), the method includes setting a position of at least the circumferential machining faces (207, 208) of the two machining tools (12, 14; 201, 202; 231, 232) in relation to the log (226, 236) to be machined independently of the respective other machining tool (12, 14; 112, 114; 201, 202; 231, 232), with the first of the machining tools (12) mounted directly and the second machining tool (14) mounted via the eccentric (24) on the common tool carrier (22), and the position of the circumferential machining face of the first machining tool (12) is set in relation to the log to be machined by adjusting the tool carrier (22) and the position of the circumferential machining face of the second machining tool (14) is set in relation to the log to be machined by rotating the eccentric (24) or the tool carrier (22).

15. The method as claimed in claim 14, further comprising optically measuring the log (226, 236) three-dimensionally before and/or after slabbing and using the measurement data to determine an optimized cutting solution which comprises the side boards (S1a, S2a, S1b, S2b), and setting the position of the circumferential machining faces of the milling heads (10, 220, 230) at a dimension determined for the side boards (S1a, S2a, S1b, S2b) in the cutting solution.

16. The method as claimed in claim 15, further comprising guiding the log (226, 236) through the saw by adjustable transport and guide rollers, following a curvature of the log, and carrying the milling heads (10, 220, 230) along as the log (226, 236) passes through, such that a resulting milled contour corresponds to the profile of the side boards (S1a, S2a, S1b, S2b) determined in the cutting solution.

17. The method as claimed in claim 14, further comprising carrying out the milling out of the corner regions either before the detachment of side boards during precutting, or before the log is split up into main and side cuts during recutting, or successively in both cases.
